(19) United States
(12) Patent Application Publication
(10) Pub. No.: US 2026/0273530 A1
(43) Pub. Date: Sep. 17, 2026

(54) Diagnostic device and method

(71) Applicant: THE UNIVESITY OF BIRMINGHAM, Birmingham, West Midlands (GB)

(72) Inventors: Pola Goldberg Oppenheimer, Birmingham (GB); Jonathan Rickard, Birmingham (GB); Emma Buchan, Birmingham (GB)

(73) Assignee: Pola Goldberg Oppenheimer, Birmingham, EN (GB)

(21) Appl. No.: 19/167,893

(22) PCT Filed: Mar. 22, 2025
(86) PCT No.: PCT/GB2024/050770

§ 371 Date: Sep. 23, 2025

(30) Foreign Application Priority Data
Mar. 23, 2023 (GB) 2304236.9

(51) Int. Cl. B01L 3/00

(52) U.S. Cl. CPC B01L 3/502753; B01L 2200/0647; B01L 2300/0681; B01L 2300/0887; B01L 2300/12; B01L 2400/0406

(57) ABSTRACT

A lab-on-a-chip (LoC) (1) comprising a plurality of sampling wells (51, 41) and a nano-porous filter (45). A first sampling well (51) in fluid communication with a second sampling well (41) via a flow path. The nano-porous filter (45) being provided in the first sampling well (51).

### TECHNICAL FIELD OF THE INVENTION

The present invention relates to a diagnostic device and methods of use thereof.

### BACKGROUND TO THE INVENTION

Aging populations have given rise to an increased demand for medical diagnostics to identify underlying illness. Where patients may present with multiple physiological diseases early detection, identification and treatment can result in improved outcomes.

The extraction, isolation and identification of extracellular vesicles (EVs) is one such way in which diseases can be identified. EVs are lipid membrane vesicles which vary in size in the submicron range. EVs are increasingly being recognised for their promising diagnostic value as circulating biomarkers of disease ‘liquid biopsies.’ EVs have been found and isolated from the extracellular space as well as diverse bodily fluids, including saliva, urine, blood and cerebrospinal fluid. EVs are considered a stable and abundant source of circulating biomarkers. The potential of EVs as biomarkers, vaccines and drug delivery vessels has attracted growing interest as EVs carry and protect cellular cargoes, including, nucleic acids, proteins and lipids from their place of origin. EVs possess many unique physical and biological properties: they comprise a heterogeneous constituency and they range in size, typically from 50-200 nm in diameter, thus they are smaller than cells (10-30 μm) but larger than proteins.

EVs are considered as reservoirs of important information as they hold key evidence as to the cells from which they originate. Acting as intracellular messengers, their role in the potential spread of disease has garnered increasing interest in recent years. They play a role in many different processes, including intercellular communication, recycling of membrane proteins and lipids, immune modulation and cellular proliferation. In many instances of age-related disease, such as for example in cardiovascular disease, the number of EVs present in biological fluids are increased. EVs can therefore act as biomarkers, specifying the progression of the disease state of the cells in which they originate.

There are presently a number of methods of isolating EVs include polymer-based precipitation, immunoaffinity, size-exclusion and the most commonly used, ultracentrifugation. These methods are unfavourable as they require expensive instrumentation, lengthy sample preparation and multiple time-consuming centrifugation steps suitable only for use in laboratory settings with input from skilled staff. The isolation can take up to 6 hours and results in low yields of EVs and poor recovery efficiency, therefore requiring large samples.

In light of this disease diagnosis using EVs is not utilised to its full potential.

It is an aim of the present invention to provide, overcome or reduce the disadvantages found in EV extraction in the prior art and to provide an improved means of disease diagnosis using EVs.

### SUMMARY OF THE INVENTION

According to a first aspect of the invention there is provided a lab-on-a-chip (LoC), the LoC comprising a plurality of sampling wells and nano-porous filters, wherein a first sampling well is in fluid communication with a second sampling well via a flow path, wherein a nano-porous filter is provided in the first sampling well.

By providing a plurality of sampling wells in fluid communication with the first sampling well comprising a nano-porous filter the LoC can isolate at least one subclass of extracellular vesicles from the biofluid sample which can then be analysed in-situ in the first sampling well by means of a remote measuring technique such as Raman spectroscopy and at least one other subclass of extracellular vesicles can be analysed in-situ in the second sampling well by means of a remote measuring technique such as Raman spectroscopy. That is to say, extracellular vesicles with dimensions greater than the pore size in the nano-porous filter are prevented from continuing along the flow path thereby collecting particular species of extracellular vesicles in the sampling well for testing in-situ.

The LoC may further comprise a capillary channel. The capillary channel may define the flow path. The capillary channel may define the flow path between the first and second sampling wells. The capillary channels may be microfluidic channels.

By utilising capillary action to draw the biofluid sample between sampling wells the LoC can function as a self-contained separation and isolation unit without requiring external forces such as ultracentrifuging or electrostatic separation. This means the LoC does not need complex lab equipment or a source of power. The test can be done outside of a lab environment.

The LoC may further comprise a first inlet well. The first inlet well and first sampling well may be contiguous, that is to say they may be integrally formed, for example by a single well or chamber. The first inlet well may be in fluid communication with the second sampling well. The first inlet well and the second sampling well may be in fluid communication via the flow path. The nano-porous filter may delimit the first inlet well and first sample well. The nano-porous filter may define the bottom of the first sampling well. The nano-porous filter may be configured to prohibit movement of extracellular vesicles above a first predetermined size into the first inlet well. The nano-porous filter may trap extracellular vesicles above a first predetermined size on a surface of the filter.

The LoC may comprise at least two sampling wells. The LoC may comprise at least three sampling wells. The LoC may comprise at least four sampling wells. The LoC may comprise at least five sampling wells.

By providing a plurality of sampling wells the LoC can be used to extract multiple data sets from a single sample, increasing the efficiency of the test.

The LoC may comprise a plurality of sampling layers. The LoC may comprise at least two sampling layers. The LoC may comprise at least three sampling layers. The LoC may comprise at least four sampling layers. The LoC may comprise at least five sampling layers. A first sampling layer may comprise the first sampling well. A second sampling layer may comprise the second sampling well. A third sampling layer may comprise a third sampling well. A fourth sampling layer may comprise a fourth sampling well. A fifth sampling layer may comprise a fifth sampling well.

The first sampling layer may be disposed on an upper surface of the second sampling layer. The second sampling layer may be disposed on an upper surface of the third sampling layer. The third sampling layer may be disposed on an upper surface of the fourth sampling layer. The fourth sampling layer may be disposed on an upper surface of the fifth sampling layer. The fifth sampling layer may be disposed on an upper surface of a substrate.

Providing the sampling layers on top of one another simplifies manufacture as the microfluidic elements and wells can be provided on an easy to access surface of the layer and subsequently be provided inside the LoC beneath another layer.

The first sampling layer may comprise a sample inlet well. The second sampling layer may comprise the first inlet well. The third sampling layer may comprise a second inlet well. The fourth sampling layer may comprise a third inlet well. The fifth sampling layer may comprise a fourth inlet well.

The first sampling layer may comprise a sample inlet well in fluid communication with the first sampling well via a first set of capillary channels. The second sampling layer may comprise a first inlet well in fluid communication with the second sampling well via a second set of capillary channels. The third sampling layer may comprise a second inlet well in fluid communication with the third sampling well via a third set of capillary channels. The fourth sampling layer may comprise a third inlet well in fluid communication with the fourth sampling well via a fourth set of capillary channels. The fifth sampling layer may comprise a fourth inlet well in fluid communication with the fifth sampling well via a fifth set of capillary channels.

The one or more or each capillary channel may be comprised of a plurality of ducts. The or more or each capillary channel may comprised of three ducts. The ducts may be parallel.

The LoC may further comprise a sample input layer. The sample input layer may comprise a sample aperture. The sample aperture may extend between an upper and lower face of the sample input layer. The sample input layer may be disposed on an upper surface of the first sampling layer. The sample aperture may be aligned with the sample inlet well.

The first sampling well may be aligned with the first inlet well. The second sampling well may be aligned with the second inlet well. The third sampling well may be aligned with the third inlet well. The fourth sampling well may be aligned with the fourth inlet well.

The first sampling well may be in fluid communication with the first inlet well. The second sampling well may be in fluid communication with the second inlet well. The third sampling well may be in fluid communication with the third inlet well. The fourth sampling well may be in fluid communication with the fourth inlet well.

The first sampling well and the first inlet well may be delimited by a first nano-porous filter. The second sampling well and the second inlet well may be delimited by a second nano-porous filter. The third sampling well and the third inlet well may be delimited by a third nano-porous filter. The fourth sampling well and the fourth inlet well may be delimited by a fourth nano-porous filter.

A base of the one, or more, or each sampling well may be defined by a nano-porous filter. A side wall of the one, or more, or each sampling well may be defined by a wall of an aperture provided through the corresponding sampling layer. The one, or more, or each sampling well may comprise an open top, in direct communication with an environment external to the LoC.

The one, or more, or each sampling well may be configured to retain one or more species of extracellular vesicles. The one, or more, or each nano-porous filter may be configured to retain extracellular vesicles in the sampling well arranged above.

A first nano-porous filter may be provided between the first sampling layer and second sampling layer. A second nano-porous filter may be provided between the second sampling layer and third sampling layer. A third nano-porous filter may be provided between the third sampling layer and fourth sampling layer. A fourth nano-porous filter may be provided between the fourth sampling layer and fifth sampling layer. Each nano-porous filter may be associated with the layer below. The first, or second, or third, or fourth, or each or a combination thereof of nano-porous filters may be arranged in the flow path between their respective sampling wells.

The first nano-porous filter may have a pore size of between 450 and 550 nm, preferably between 475 and 525 nm, more preferably between 490 and 510 nm, for example 500 nm.

The second nano-porous filer may have a pore size of between 150 and 250 nm, preferably between 175 and 225 nm, more preferably between 190 and 210 nm, for example 200 nm.

The third nano-porous filer may have a pore size of between 50 and 150 nm, preferably between 75 and 125 nm, more preferably between 90 and 110 nm, for example 100 nm.

The fourth nano-porous filer may have a pore size of between 20 and 60 nm, preferably between 30 and 50 nm, more preferably between 35 and 45 nm, for example 40 nm.

A micro/nano-porous filter may be provided between the sample aperture and the sample inlet well. The micro/nano-porous filter may be provided between the sample aperture and the sample inlet well may be a debris filter. The debris filter may be arranged between the sample input layer and the first sampling layer. The debris filter may have a pore size of more than 5000 nm.

The nano-porous filter pore size for each layer may be less than the nano-porous filter pore size for the layer above. The second nano-porous filter may have a smaller pore size than the first nano-filter. The third nano-porous filter may have a smaller pore size than the second nano-filter. The fourth nano-porous filter may have a smaller pore size than the third nano-filter.

There may be a single flow path from the inlet well to the second sampling well. There may be a single flow path from the inlet well to the third sampling well. There may be a single flow path from the inlet well to the fourth sampling well. There may be a single flow path from the inlet well to the fifth sampling well. There may be a single flow path from the inlet well to the final sampling well.

The flow path may include the sampling wells sequentially. The flow path may comprise sequential flow from the first sampling well to a last sampling well. That is, the flow path passed through each of the sampling wells sequentially, i.e. the sample (being drawn along the flow path) starts in the sample inlet well, then passing into the first sampling well, then into the second sampling well and so on until the last sampling well, with only a single flow path for constituent parts of the sample to flow along until they are stopped by a nano-porous filter. This is advantageous as it means the various subclasses of EVs are extracted from the entire sample. It also makes the design modular, little modification to the overall design is required to increase or decrease the number of sampling wells. Furthermore, it allows the selection of the subclasses to be readily determined only by changing the nano-porous filters.

The first sampling layer may be arranged on top of the second sampling layer. The first sampling layer may be disposed on an upper surface of the second sampling layer. The second sampling layer may be arranged on top of the third sampling layer. The second sampling layer may be disposed on an upper surface of the third sampling layer. The third sampling layer may be arranged on top of the fourth sampling layer. The third sampling layer may be disposed on an upper surface of the fourth sampling layer. The fourth sampling layer may be arranged on top of the fifth sampling layer. The fourth sampling layer may be disposed on an upper surface of the fifth sampling layer.

The first sampling layer may not extend over the second sampling well. The second sampling layer may not extend over the third sampling well. The third sampling layer may not extend over the fourth sampling well. The fourth sampling layer may not extend over the fifth sampling well.

The length of each layer may be less that the layer below. The first layer may have a length of between 30 and 40 mm, for example 35 mm. The second layer may have a length of between 45 and 55 mm, for example 50 mm. The third layer may have a length of between 60 and 70 mm, for example 65 mm. The fourth layer may have a length of between 75 and 85 mm, for example 80 mm. The fifth layer may have a length of between 90 and 100 mm, for example 95 mm.

The layers may all have the same width. The layers may have a width of between 20 and 30 mm, for example 25 mm. The layers may be aligned along their respective long edges. The layers may be aligned along one of their short edges. The LoC may have an overall step shape.

The length of each layer being less than that of the layer below is advantageous as it allows ready access to the sampling wells for various sampling methods without the layers above interfering.

The sample inlet well may have a diameter of between 6 and 10 mm for example 8 mm. One, more or each of the first, second, third and fourth sample inlet wells may have a diameter of between 6 and 10 mm for example 8 mm.

One, more or each of the first, second, third and fourth sampling wells may have a diameter of between 6 and 10 mm for example 8 mm.

The capillary channels may have a width of between 0.03 and 0.07 mm, preferably between 0.04 and 0.06 mm, for example 0.05 mm.

The capillary channels may have a depth of 0.05 mm between 0.03 and 0.07 mm, preferably between 0.04 and 0.06 mm, for example 0.05 mm.

The capillary channels may have a ratio between height and width (aspect ratio) of between 0.5 and 2.

The LoC may further comprise one or more capillary wells. The capillary well(s) may be in (direct) fluid communication with the final sampling well. The capillary well(s) may be in (direct) fluid communication with the sampling well in the lower most layer. The capillary well(s) may be in (direct) fluid communication with the fifth sampling well. The capillary well(s) may be in (direct) fluid communication via capillary channels.

The capillary wells help to draw the fluid sample through the device.

The (sampling) layers may be formed of a polymer. The (sampling) layers may be formed of polydimethylsiloxane. The sampling layers may be formed of glass. The sampling layers may be formed of silicon. The sampling layers may be arranged on a substrate. The substrate may comprise glass.

The first sampling well may be configured to isolate (and optionally trap) apoptotic bodies. The second sampling well may be configured to isolate (and optionally trap) microvesicles. The third sampling well may be configured to isolate (and optionally trap) large exosomes. The fourth sampling well may be configured to isolate (and optionally trap) small exosomes. The fifth sample well may be configured to isolate (and optionally trap) proteins. Each sampling well may be configured to isolate (and optionally trap) one or more species of extracellular vesicles.

The first sampling well may comprise an open top. The second sampling well may comprise an open top. The third sampling well may comprise an open top. The fourth sampling well may comprise an open top. The fifth sampling well may comprise an open top. Each sampling well may comprise an open top.

According to a second aspect of the invention there is provided a method of separating extracellular vesicles utilising a lab-on-a-chip (LoC) the LoC comprising a plurality of sampling wells and one or more nano-porous filters, wherein a first sampling well is in fluid communication with a second sampling well via a flow path, wherein the nano-porous filter is provided in the first sampling well, the method comprising: applying a biofluid sample comprising extracellular vesicles to a start point of the flow path; the biofluid sample being drawn though each sampling well sequentially; the extracellular vesicles being separated by the one or more filters into a plurality of subclasses determined by their size, each subclass being isolated in a separate sampling well.

The LoC may be the LoC of the first aspect of the invention, including any optional features thereof.

According to a broad aspect of the invention there is provided a method of diagnosis utilising a lab-on-a-chip (LoC), the method comprising: applying a biofluid sample comprising extracellular vesicles to the LoC, drawing the biofluid sample through the LoC, using filters to separate the extracellular vesicles into a plurality of subclasses determined by their size, each subclass being isolated in a separate sampling well, collecting identifying data on the extracellular vesicles in each sampling well.

The LoC may be the LoC of the first aspect of the invention, including any optional features thereof.

According to a broad aspect of the invention there is provided a method of diagnosis utilising a lab-on-a-chip (LoC). The LoC preferably comprising an inlet well. The LoC preferably comprising at least two sampling wells arranged in succession. The two sampling wells may be in fluid communication via capillary channels. A nano-porous filter may be provided between the inlet well and a first sampling well. Nano-porous filters may be provided between adjacent sampling wells. Preferably each successive filter has a smaller pore size. The method may comprise applying a biofluid sample comprising extracellular vesicles to the inlet well. The method may comprise applying a biofluid sample comprising extracellular vesicles to a first sampling well. The method may further comprise drawing the biofluid sample along the succession of sampling wells via the capillary channels. The method may further comprise using the filters to separate the extracellular vesicles into a plurality of subclasses determined by their size. Each subclass preferably being isolated in a separate sampling well. The method may further comprise collecting identifying data on the extracellular vesicles in each sampling well.

Accordingly, in a third aspect of the invention there is provided a method of diagnosis utilising a lab-on-a-chip (LoC), the LoC comprising an inlet well and at least two sampling wells arranged in succession and in fluid communication via capillary channels, wherein a nano-porous filter is provided between the inlet well and a first sampling well and between adjacent sampling wells, wherein each successive filter has a smaller pore size, the method comprising: applying a biofluid sample comprising extracellular vesicles to the inlet well, drawing the biofluid sample along the succession of sampling wells via the capillary channels, using the filters to separate the extracellular vesicles into a plurality of subclasses determined by their size, each subclass being isolated in a separate sampling well, collecting identifying data on the extracellular vesicles in each sampling well.

By collecting identifying data on the extracellular vesicles in each sampling well a larger data set is achieved in a single test. Further, by separating the sample into a plurality of subclasses the data is clearer as the subclasses do not interfere with one another.

The LoC of the second aspect may be the LoC of the first aspect, including any optional features thereof.

The method may further comprise comparing the identifying data of each sampling well to markers of known diseases.

The method may further comprise using the identifying data to establish markers for diseases.

Collection of the identifying data may comprise scanning one or more or each of the sampling wells with a Raman spectrometer to acquire Raman Spectra. The Raman spectra of one or more of each of the sampling wells may be compared with reference Raman spectra of known diseases. The comparison may utilise a neural network to form a self-organising map to provide a visual classification of the data.

The method may further comprise the step of pre-wetting the filters with a buffer solution. The filters may be pre-wetted prior to applying the biofluid sample to the inlet well. The buffer solution may be applied to the inlet well. The buffer may be phosphate-buffered saline.

At least one of the separated subclasses may be apoptotic bodies. At least one of the separated subclasses may be microvesicles. At least one of the separated subclasses may be exosomes. At least one of the separated subclasses may be proteins.

The biofluid sample may comprise saliva, urine, blood, breastmilk, cerebrospinal fluid or any other biofluid from a human or animal. The biofluid sample may be extracted from saliva, urine, blood, breastmilk or cerebrospinal fluid.

### DETAILED DESCRIPTION OF THE INVENTION

In order that the invention may be more clearly understood one or more embodiments thereof will now be described, by way of example only, with reference to the accompanying drawings, of which:

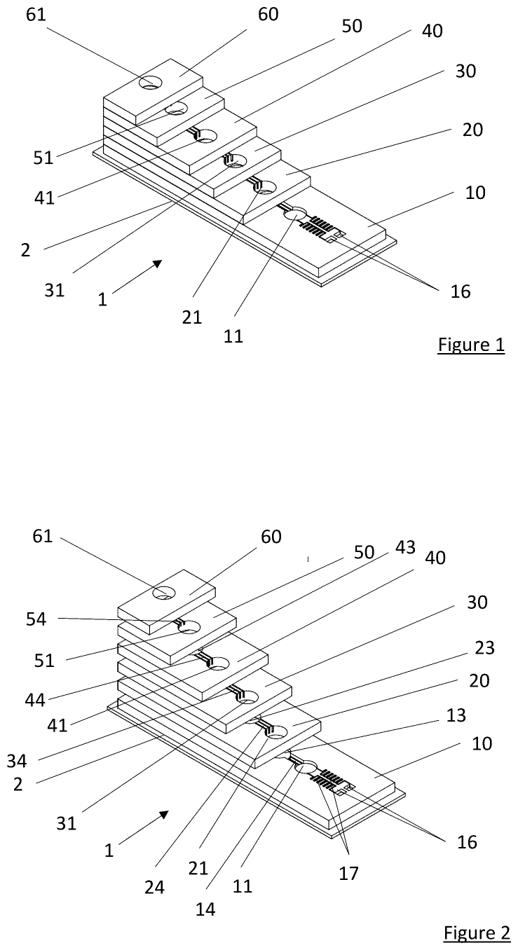

FIG. 1 shows a perspective view of a lab-on-a-chip according to an aspect of the invention;

FIG. 2 shows an exploded perspective view of the lab-on-a-chip of FIG. 1;

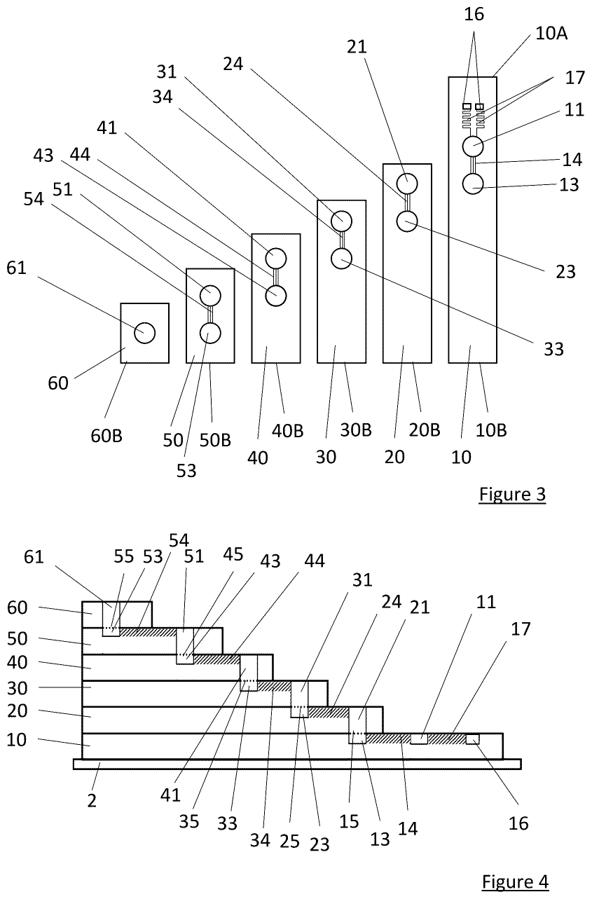

FIG. 3 shows a plan view the individual layers of the lab-on-a-chip of FIG. 1;

FIG. 4 shows a cross-sectional view of the lob-on-a-chip of FIG. 1;

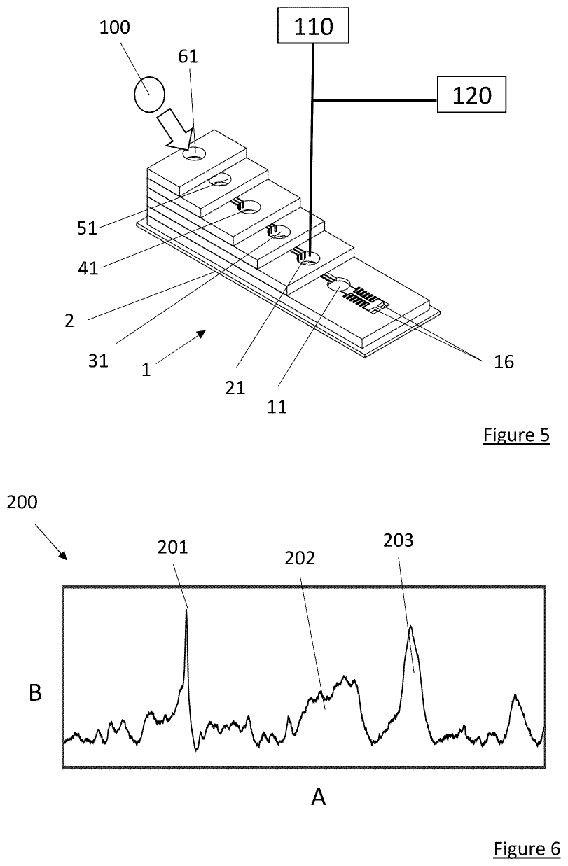

FIG. 5 shows a schematic view of an apparatus using the lab-on-a-chip of FIG. 1 in diagnosis; and

FIG. 6 shows an exemplary spectrum as recorded by the apparatus of FIG. 5.

With reference to FIG. 1 to 5 a lab-on-a-chip (LoC) is described in detail. The LoC 1 comprises a planar substrate 2 upon which one or more filtration and isolation layers 10,20,30,40,50 are provided. In order from the substrate up the individual filtration and isolation layers are a protein layer 10, a first, lower, exosomes layer 20, a second, upper, exomes layer 30, a microvesicles layer 40, an apoptotic bodies layer 50. Each of the layers 10,20,30,40,50 is planar and has a rectangular shape with two longitudinal edges and two transverse edges. Both of the longitudinal edges and a first transverse edge 10B,20B,30B,40B,50B, of each layer are aligned. The length of each layer 20,30,40,50 is less than that of the layer below 10,20,30,40 such that the LoC 1 has an overall step shaped profile.

On top of the apoptotic bodies layer 50 is provided a sample inlet layer 60, like the other layers this has a rectangular shape and both longitudinal edges 60A and one transverse edge 60B are aligned with the other layers. The sample inlet layer 60 is the same width as the other layers and shorter than the apoptotic bodies layer 50 thus forming a further step on the chip 1.

The substrate 2 is formed of glass and each of the filtration and isolation layers 10,20,30,40,50, and sample inlet layer 60 are formed of polydimethylsiloxane (PDMS) however it will be appreciated that other materials suitable for the fabrication of microfluidic chips such as glass, silicon or polymers could be used.

As can be seen in FIGS. 1 to 3 the sample inlet layer 60 comprises a circular sample inlet aperture 61 extending between upper 62 and lower (not shown) faces of the sample inlet layer 60. The aperture has a diameter of 8 mm.

As noted above, below the sample inlet layer 60 is the apoptotic bodies layer 50. The apoptotic bodies layer 50 comprises an apoptotic bodies inlet well 53 and an apoptotic bodies layer aperture 51 extending between upper 52 and lower (not shown) faces of the apoptotic bodies layer 50.

The apoptotic bodies inlet well 53 has a circular profile with an 8 mm diameter and is arranged proximal to the first transverse edge of the apoptotic bodies layer 50B. It is the same distance from the first transverse edge of the apoptotic bodies layer 50B as the sample inlet aperture 61 is from the first transverse edge of the sample inlet layer 60B such that the sample inlet aperture 61 and apoptotic bodies inlet well 53 are aligned. The apoptotic bodies inlet well 53 has a depth of 3 mm.

The sample inlet aperture 61 and apoptotic bodies inlet well 53 are separated by a debris filter 55 which is comprised of a micro-porous polyethersulfone hydrophilic membrane with a pore size of 5000 nm arranged between the sample inlet layer 60 and the apoptotic bodies layer 50.

The apoptotic bodies layer aperture 51 is arranged distal to the first transverse edge of the apoptotic bodies layer 50B and has a diameter of 8 mm.

The apoptotic bodies inlet well 53 and the apoptotic bodies layer aperture 51 are in fluid communication via three straight microfluidic channels 54 which extend there between. The microfluidic channels have a width of 0.05 mm and depth of 0.05 mm

Below the apoptotic bodies layer 50 is the microvesicles layer 40. The microvesicles layer 40 comprises an microvesicles inlet well 43 and an microvesicles layer aperture 41 extending between upper 42 and lower (not shown) faces of the microvesicles layer 40.

The microvesicles inlet well 43 has a circular profile with an 8 mm diameter and is arranged proximal to the first transverse edge of the microvesicles layer 40B. It is the same distance from the first transverse edge of the microvesicles layer 40B as the apoptotic bodies layer aperture 51 is from the first transverse edge of the apoptotic bodies layer 50B such that the apoptotic bodies aperture 51 and microvesicles inlet well 43 are aligned. The microvesicles inlet well 43 has a depth of 3 mm.

The apoptotic bodies aperture 51 and microvesicles inlet well 43 are separated by an apoptotic bodies filter 45 which is comprised of a nano-porous polyethersulfone hydrophilic membrane with a pore size of 500 nm arranged between the apoptotic bodies layer 50 and the microvesicles layer 40.

The microvesicles layer aperture 41 is arranged distal to the first transverse edge of the microvesicles layer 40B and has a diameter of 8 mm.

The microvesicles inlet well 43 and the microvesicles layer aperture 41 are in fluid communication via three straight microfluidic channels 44 which extend therebetween. The microfluidic channels have a width of 0.05 mm and depth of 0.05 mm.

Below the microvesicles layer 40 is the first, upper exosome layer 30. The upper exosome layer 30 comprises an upper exosome inlet well 33 and an upper exosomes layer aperture 31 extending between upper 32 and lower (not shown) faces of the exosome layer 30.

The upper exosomes inlet well 33 has a circular profile with an 8 mm diameter and is arranged proximal to the first transverse edge of the upper exomes layer 30B. It is the same distance from the first transverse edge of the microvesicles layer 30B as the microvesicles layer aperture 41 is from the first transverse edge of the microvesicles layer 40B such that the microvesicles aperture 41 and upper exosomes inlet well 33 are aligned. The upper exosomes inlet well 33 has a depth of 3 mm.

The microvesicles aperture 41 and upper exomes inlet well 33 are separated by a microvesicles filter 35 which is comprised of a nano-porous polyethersulfone hydrophilic membrane with a pore size of 200 nm arranged between and the microvesicles layer 40 and the upper exosomes layer 30.

The upper exosomes layer aperture 31 is arranged distal to the first transverse edge of the upper exosomes layer 30B and has a diameter of 8 mm.

The upper exomes inlet well 33 and the upper exosomes layer aperture 31 are in fluid communication via three straight microfluidic channels 34 which extend therebetween. The microfluidic channels have a width of 0.05 mm and depth of 0.05 mm

Below the upper exosomes layer 30 is the second, lower exosome layer 20. The lower exosome layer 20 comprises a lower exosome inlet well 23 and a lower exosomes layer aperture 21 extending between upper 22 and lower (not shown) faces of the exosome layer 20.

The lower exosomes inlet well 23 has a circular profile with an 8 mm diameter and is arranged proximal to the first transverse edge of the lower exosomes layer 20B. It is the same distance from the first transverse edge of the lower exosomes layer 20B as the upper exosomes layer aperture 31 is from the first transverse edge of the upper exosomes layer 30B such that the upper exosomes aperture 31 and lower exosomes inlet well 23 are aligned. The lower exosomes inlet well 23 has a depth of 3 mm.

The upper exosomes aperture 31 and lower exosomes inlet well 23 are separated by a large exosomes filter 25 which is comprised of a nano-porous polyethersulfone hydrophilic membrane with a pore size of 100 nm arranged between and the upper exosomes layer 30 and the lower exosomes layer 20.

The lower exosomes layer aperture 21 is arranged distal to the first transverse edge of the lower exosomes layer 20B and has a diameter of 8 mm.

The lower exosomes inlet well 23 and the lower exomes layer aperture 21 are in fluid communication via three straight microfluidic channels 24 which extend therebetween. The microfluidic channels have a width of 0.05 mm and depth of 0.05 mm

Below the lower exosomes layer 20 is the protein layer 10. The protein layer 10 comprises a protein inlet well 13, a protein sample well 11 and two capillary wells 16.

The protein inlet well 13 has a circular profile with an 8 mm diameter and is arranged proximal to the first transverse edge of the protein layer 10B. It is the same distance from the first transverse edge of the protein layer 10B as the lower exomes layer aperture 21 is from the first transverse edge of the lower exomes layer 20B such that the lower exomes aperture 21 and protein inlet well 23 are aligned. The protein inlet well 23 has a depth of 3 mm.

The lower exosomes aperture 21 and protein inlet well 13 are separated by a small exosomes filter 15 which is comprised of a nano-porous polyethersulfone hydrophilic membrane with a pore size of 40 nm arranged between and the lower exosomes layer 20 and the protein layer 10.

The protein sample well 11 is arranged distal to the first transverse edge of the protein layer 10B and has a diameter of 8 mm and a depth of 3 mm. Proximal to a second transverse edge of the protein layer 10A are provided the two capillary wells 16. The capillary wells 16 are rectangular in shape with a long end parallel to the second transverse edge of the protein layer 10A having a length of 6 mm and a width of 3 mm. The two capillary wells are equal distance from the protein sample well 11 and approximately at the midpoint between the protein sample well 11 and the second transverse edge of the protein layer 10A.

The protein inlet well 13 and the protein sample well 11 are in fluid communication via three straight microfluidic channels 14 which extend therebetween. The protein sample well 11 is in fluid communication with each of the capillary wells 16, both via capillary microfluidic channels 17 which follows a square zig-zag path. The microfluidic channels have a width of 0.05 mm and depth of 0.05 mm. As will be appreciated by those skilled in the art the number and dimensions of microfluidic channels 17 may be varied to change the capillary force on the sample and thus change the time taken for the sample to pass through the system 1.

The individual layers 10,20,30,40,50,60 once combined provide a single fluid pathway from the sample inlet aperture 61 to the protein sample well 11. This is to say the sample inlet aperture 61 is in fluid communication with the apoptotic inlet well 53, separated by the debris filter 55; the apoptotic inlet well 53 is in fluid communication with the apoptotic layer aperture 51 via three microfluidic channels 54; the apoptotic layer aperture 51 in is fluid communication with the microvesicles inlet well 43, separated by the 500 nm filter; the microvesicles layer aperture 41 in is fluid communication with the microvesicles inlet well 43 via three microfluidic channels 44; the microvesicles layer aperture 41 in is fluid communication with the upper exosomes inlet well 33, separated by the 200 nm filter; the upper exosomes layer aperture 31 is in fluid communication with the upper exomes inlet well via three microfluidic channels 34; the upper exosomes aperture 31 is in fluid communication with the lower exosomes inlet well 23, separated by the 100 nm filter; the lower exosomes layer aperture 21 in is fluid communication with the protein inlet well 13; the protein sample well 11 is in fluid communication with the protein inlet well 13 via three microfluidic channels 14.

Each of the filtering and isolation layers 10,20,30,40,50,60 are made using 3D resin printed micro moulds of high temperature resolution resistance resin (Siraya Tech, USA). The moulds are printed using a monochrome LCD/MSLA resin printer equipped with a 405 nm light source (Elegoo Mars 3, China). The moulds are thoroughly washed in isopropyl alcohol for 20 minutes, baked at 120° C. and cured under an ultraviolet lamp (Elegoo, China) for 20 minutes to prevent mould/PDMS interaction. The PDMS (Dow corning, USA) is mixed in a ratio of 5:1 with curing agent Sylgard™ 184 (Dow Corning, USA). The nano-porous polyethersulfone hydrophilic membrane (Sterlitech, USA) filters of 25 mm diameter with varying pore sizes (5000, 500, 200, 100 and 40 nm) are placed between the PDMS layers. PDMS layers are bonded through a combination of plasma cleaning layers for 10 minutes followed by hard baking at 120° C. for 30 minutes.

With reference to FIG. 5 to 7 a method of diagnosis using the LoC is described. Prior to injection of a sample of bio-fluid 200 for testing, 1 mL of phosphate-buffered saline (PBS) is injected into the sample inlet aperture 61 to pre-wet the filter membranes 55,45,35,25,15. After 10 minutes, inlet PBS is replaced with 100 μL of sample bio-fluid 200. The sample bio-fluid 200 may be one of a number of bodily fluids, including saliva, urine, blood and cerebrospinal fluid, extracted from a patient prior to testing. 500 μL of the sample bio-fluid 200 is diluted with PBS in 1:1 ratio and injected into the sample inlet aperture 61. The sample bio-fluid 200 is drawn by capillary action through the debris filter 55, the debris filter 55 prevents cellular debris, or where saliva is the bio-fluid, food, contaminating the test results. The sample bio-fluid now proceeds into the apoptotic bodies inlet well 53 and is drawn by to the apoptotic bodies layer aperture 51 via the capillary channels 54, the 500 nm filter 45 prevents EVs of between 5000 and 500 nm from proceeding further, therefore the apoptotic bodies layer aperture 51 also acts as an apoptotic bodies sample well 51. The remaining bio-fluid 200 collects in the microvesicles inlet well 43 and is drawn via the capillary channels 44 to the microvesicles layer aperture 41, where the 200 nm filter prevents EVs of between 500 and 200 nm from proceeding further. Thus, the microvesicles layer aperture 41 also acts as a microvesicles sample well 41. The remaining bio-fluid 200 collects in the upper exosomes inlet well 33 and is drawn via the capillary channels 34 to the upper exosomes layer aperture 31, where the 100 nm filter prevents EVs of between 200 and 100 nm from proceeding further. Thus, the upper exosomes layer aperture 31 also acts as an upper exosomes sample well 31. The remaining bio-fluid 200 collects in the lower exosomes inlet well 23 and is drawn via the capillary channels 24 to the lower exosomes layer aperture 21, where the 40 nm filter prevents EVs of between 100 and 40 nm from proceeding further. Thus, the lower exosomes layer aperture 21 also acts as a lower exosomes sample well 21. The remaining bio-fluid collects in the protein inlet well 13 and is drawn via capillary channels 14 to the protein sample well 11 where it is collected. From application of the bio-fluid sample 200 to the collection in the protein sample well takes between 5 and 10 minutes.

Raman spectroscopy is then performed directly on the LoC 1 at each sample well 51,41,31,21,11. Raman spectra 200 are acquired using a suitable Raman spectrometer 120, for example a Renishaw In Via Qontor confocal Raman microscope equipped with a microscope Leica DMLM (Renishaw PLC, UK). A 785 nm excitation laser 110 is used with the laser light focussed using ×50 objective. Output power at the sample is 25 mW. The Raman spectra were acquired in the main fingerprint region of 700-1700 cm⁻¹. Raman spectra were obtained over a 50×50 μm map for each sample well 51,41,31,21,11 using a 5 μm step size between map points, 10 accumulations of 1 second acquisition per spectra. As will be appreciated by those skilled in the art the specific type of Raman microscope could be varied, as could the scan parameters. The also envision the use of handheld Raman systems to allow the system to be used in the community.

The Raman data are acquired using suitable software such as WiRE 5.1 (Renishaw PLC, UK) and for the polynomial background subtraction. WiRE 5.1 is also used to remove cosmic rays. The resultant spectra 200 are normalised using the standard normal variate (SNV) using Python (Python 3.7). Signal-to-noise ratio is improved by using 10 averaged spectra at each map location. Multivariate analysis is then performed using the open-source analysis tool, SKINET, alongside the Raman Toolkit web interface to build the self-organised map (SOM) models. SKINET acts as a decision support tool and is based on the separation of data classes in the form of the SOM with characterisation using the self-organised map discriminant index (SOMDI) thus, enabling the classification of the test data.

An example spectrum 200 from a Raman scan of one sample well 51,41,31,21,11 is shown in FIG. 6, the x-axis is Raman Shift (A) and the y-axis is intensity (B). The spectra can be analysed in two primary ways.

Where a disease is well mapped using the technique specific markers or fingerprints can be measured in the spectra 200 of each of the wells individually and the resultant spectra analysed together. These markers or fingerprints are in the form of spectral peaks 201,202,203 which when analysed using SKiNET can provide diagnosis as to the presence of the disease being tested for. The separation of the various EV subclasses prior to undertaking the Raman scanning is advantageous as it simplifies the resulting spectra and reduces the “clutter” enabling clear analysis.

The apparatus can also be used to map new diseases to determine whether the technique is suitable for testing for the presence of the disease. In such cases a series of samples from patients known to have the disease can be tested and the spectra compared with spectra from a second series of samples from subjects without the disease. SKINET can then compare the two data sets and identify fingerprints in the spectra that can be used in future diagnostic tests.

Whilst the above methodology describes in detail the use of Raman spectroscopy in the analysis of the EV contents of the wells 51,41,31,21,11, other measurement techniques such as mass spectrometry could also be used.

The one or more embodiments are described above by way of example only. Many variations are possible without departing from the scope of protection afforded by the appended claims.

1. A lab-on-a-chip (LoC), the LoC comprising a plurality of sampling wells and a nano-porous filter;
wherein a first sampling well is in fluid communication with a second sampling well via a flow path,
wherein the nano-porous filter is provided in the first sampling well.

2. An LoC according to claim 1 further comprising a capillary channel, wherein the capillary channel defines the flow path.

3. An LoC according to claim 1 further comprising a first inlet well, wherein the first inlet well and first sampling well are contiguous and in fluid communication and the first inlet well is in fluid communication with the second sampling well via the flow path, wherein the nano-porous filter delimits the first inlet well and first sample well.

4. An LoC according to claim 1, wherein the LoC comprises a plurality of sampling layers; wherein a first sampling layer comprises the first sampling well and a second sampling layer comprises the second sampling well; the first layer being arranged on top of the second layer.

5. An LoC according to claim 4, wherein the first inlet well is provided on the second layer and the nano-porous filter is arranged between the two layers.

6. An LoC according to claim 4 wherein each sampling layer comprises an inlet well and a sampling well connected via a flow path, and a nano-porous filter;
wherein in the inlet well of each layer is contiguous with the sampling well of the layer above and the nano-porous filter is provided between the layer and the layer above to delimit the inlet well and sampling well of the layer above.

7. An LoC according to claim 6 wherein the nano-porous filter pore size for each layer is less than the nano-porous filter pore size for the layer above.

8. An LoC according to claim 6, wherein the length of each layer is less than the layer below.

9. An LoC according to claim 8 wherein each layer does not extend over the sampling well of the layer below.

10. An LoC according to claim 6 comprising five sampling layers.

11. An LoC according to claim 10 wherein the first sampling well is configured to isolate apoptotic bodies, the second sampling well is configured to isolate microvesicles, and a third sampling layer comprises a third sampling well is configured to isolate large exosomes, a fourth sampling layer comprises a fourth sampling well is configured to isolate small exosomes and a fifth sampling layer comprises a fifth sampling well is configured to isolate proteins.

12. An LoC according to claim 11 wherein the first sampling layer comprises a nano-porous filter with a pore size of 5000 nm, the second sampling layer comprises a nano-porous filter with a pore size of 500 nm, the third sampling layer comprises a nano-porous filter with a pore size of 200 nm, the fourth sampling layer comprises a nano-porous filter with a pore size of 100 nm, and the fifth sampling layer comprises a nano-porous filter with a pore size of 40 nm.

13. An LoC according to claim 4 further comprising a sample input layer, the sample input layer comprising an aperture extending between an upper and lower face thereof, wherein the sample input layer is arranged on top of the first sampling layer and the aperture is aligned with a first layer inlet well on the first layer, wherein the first layer inlet well is in fluid communication with the first sample well via a fluid channel.

14. An LoC according to claim 11 wherein the fifth sampling layer further comprises one or more capillary wells, wherein each capillary well is in fluid communication with the fifth sampling well.

15. An LoC according to claim 4 wherein the layers comprise polydimethylsiloxane.

16. An LoC according to claim 1 wherein the flow path comprises sequential flow from the first sampling well to a last sampling well.

17. (canceled)

18. A LoC according to claim 1 wherein each sampling well comprises an open top.

19. An LoC according to claim 18 wherein the open top of each sampling well is in direct communication with an environment external to the LoC.

20. An LoC according to any preceding claim wherein each sampling well is configured to isolate and trap one or more species of extracellular vesicles.

21. A method of separating extracellular vesicles utilising a lab-on-a-chip (LoC) according to any preceding claim, the method comprising:
applying a biofluid sample comprising extracellular vesicles to a start point of the flow path;
the biofluid sample being drawn though each sampling well sequentially;
the extracellular vesicles being separated by the one or more filters into a plurality of subclasses determined by their size, each subclass being isolated in a separate sampling well.
